(19) United States
(12) Patent Application Publication
(10) Pub. No.: US 2006/0087493 A1
(43) Pub. Date: Apr. 27, 2006

(54) Display device of identification card

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/969,992

(22) Filed: Oct. 22, 2004

(51) Int. Cl. G09G 5/00

(52) U.S. Cl. 345/156

(57) ABSTRACT

An improved display device of an identification card is disclosed. The display device having a main body mounted thereon comprises: several function buttons, a speaker, a monitor, a microphone, a camera lens, a slot for a storage device, an input/output device, a connection part, and several receiving clips mounted on the main body. A MP3 playing circuit and a Bluetooth chip module are mounted on the inside of the main body. As a result, the identification card, a MP3 player, a mobile phone, etc are integrated with one another by using the receiving clips for receiving an identification card and the connection part for coupling with a string that can be hung on the neck so as to prevent from hanging various disorderly and confused articles.

### BACKGROUND OF THE INVENTION

The present invention relates to an improved display device of an identification card that has integrated functions. The display device is applied to an office, a residence house, or the like.

In order to control members of offices or residence houses in multi-storey buildings, mostly common way is to allot an identification card, which is verified by building guarders or entrance-guarding machines, to a corresponding member. Besides, in order to facilitate the building guarder to perform the identification step, the identification card is usually hung on the neck of the user by a string. In addition, the popular MP3 player is also hung on the neck by another string. Moreover, a mobile phone is sometimes hung on the neck by still another string to prevent it from losing or missing an important phone call. As a result, there are a lot of basic equipments hung on the neck of the user. It is not pleasing to the eye and not easy for use.

If only the identification card is hung on the neck while the MP3 player and mobile phone are put inside a pocket or a handbag by taking the pleasant appearance into consideration, the earphone cord of the MP3 player will limit the usage of this manner. If there is an incoming phone call, the user will miss the timing of answering the phone call since he needs to look for the mobile phone in the handbag. The important message is thus missed.

In view of the above circumstances, the present inventor has been made diligent studies with a quiet mind to design and fabricate an improved display device of an identification card that has integrated functions and does not result in the unpleasant appearance of the user. This display device is provided for the consumer in accordance with motivations of the present invention.

### SUMMARY OF THE INVENTION

The primary purpose of the present invention is to provide an improved display device of an identification card with integrated functions to prevent the user from hanging various structures, for example, the identification card, a MP3 player, or a mobile phone, on his neck.

The secondary purpose of the present invention is to provide an improved display device of an identification card that enables the user to keep the orderly and comely appearance.

According to the aforementioned purposes of the present invention, an improved display device of an identification card is disclosed. The display device having a main body mounted thereon comprises: several function buttons, a speaker, a monitor, a microphone, a camera lens, a slot for a storage device, an input/output device, a connection part, and several receiving clips mounted on the main body. A MP3 playing circuit and a Bluetooth chip module are mounted on the inside of the main body. As a result, the identification card, a MP3 player, a mobile phone, etc are integrated with one another by using the receiving clips for receiving an identification card and the connection part for coupling with a string that can be hung on the neck so as to prevent from hanging various disorderly and confused articles.

The other features and preferred embodiments of the present invention will now be described with reference to the accompanying drawings.

### BRIEF DESCRIPTION OF THE DRAWINGS

FIG. 1 is a perspective view showing appearance of a preferred embodiment of the present invention.

FIG. 2 is a block diagram showing circuitry of a preferred embodiment of the present invention.

FIG. 3 is a schematic diagram showing usage of a display device of an identification card in accordance with the preferred embodiment of the present invention.

FIG. 4 is a schematic diagram showing usage of a hand-free mobile phone handset in accordance with the preferred embodiment of the present invention.

FIG. 5 is a schematic diagram showing usage of an entrance card in accordance with the preferred embodiment of the present invention.

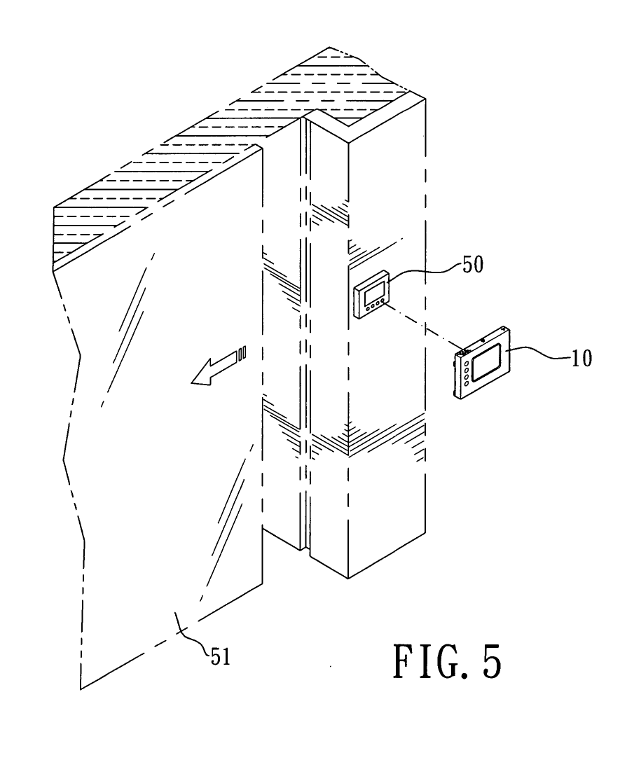

### DETAILED DESCRIPTION OF THE PREFERRED EMBODIMENT

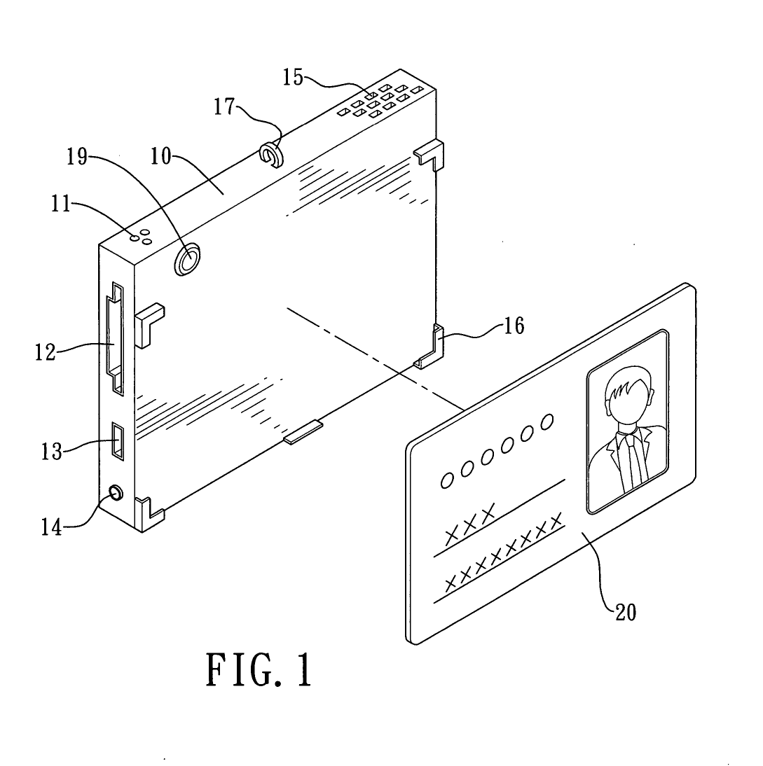

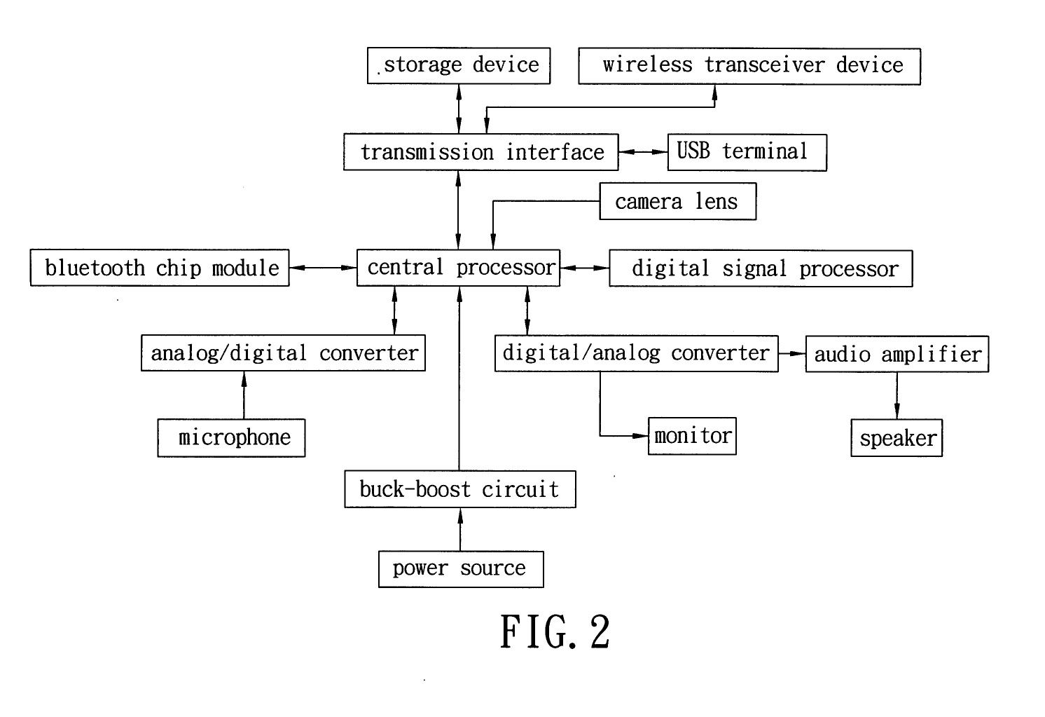

Referring to FIG. 1 and FIG. 2, the display device of the present invention primarily comprises a main body 10 having a proper size. Several receiving clips 16 are mounted on proper positions of the top edge and bottom edge on the front surface of the main body 10, wherein a shallow outstanding part is mounted on the bottom edge of the main body 10 between two receiving clips 16. Besides, a microphone 11, a slot 12 for a storage device, a USB terminal 13, an earphone jack 14, a speaker 15, a connection part 17, a camera lens 19, a monitor, and several function buttons are mounted on the periphery of the main body 10. A central processing unit (CPU) is mounted on the inside of the main body 10, wherein the CPU is further connected to an analog to digital converter, a digital to analog converter, an audio amplifier, a digital signal processor, and a transmission interface so as to form a MP3 playing circuit, and the CPU is further connected to the camera lens 19 and a Bluetooth chip module.

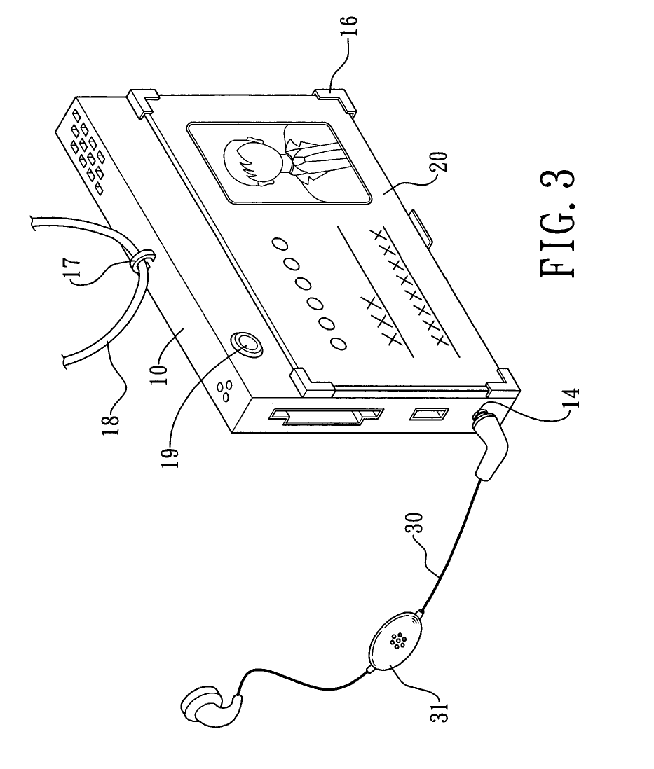

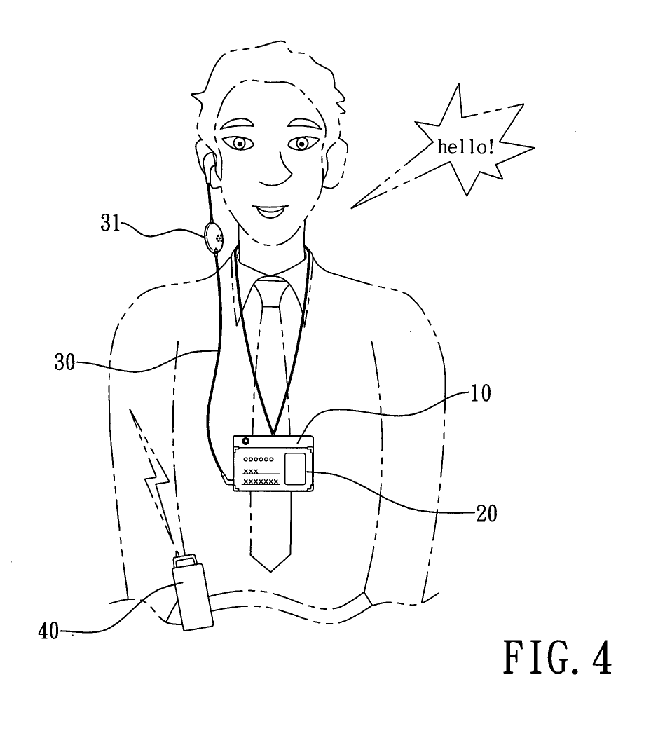

Please refer to FIG. 3 simultaneously, a string 18 may be applied to couple with the connection part 17 on the main body 10 such that the main body 10 can be hung on the neck of the user. The receiving clips 16 mounted on the front surface of the main body 10 receive a name card or an identification card so as to form a name card holder for easy use or a display device that facilitate guarder to identify the identification card. In addition, a hand-free mobile phone handset 30 having a microphone 31 can be plugged into the earphone jack 14 of the main body 10. In normal condition, when the switch of the main body 10 is turned on, the handset 30 will broadcast digital music stored in the main body 10. If there is an incoming call for the user who carries the mobile phone 40, as shown in FIG. 4, the main body 10 will change automatically from the status of showing music to the status of answering call once the Bluetooth chip module receives a signal of the incoming call. Therefore, the user will not miss the timing to answer the call because it is not necessary for the user to look for the mobile phone 40.

Furthermore, the main body 10 forms a recorder through the microphone 11 or a digital camera through the camera lens 19 by pressing the function buttons on the main body 10. In addition, an optional radio frequency identification (RFID) system is mounted on the main body 10. A card reader 50 is utilized to access RFID identification codes stored in main body 10 so as to open the door panel 51 thereby achieving the purpose of entrance control. Besides, a LED light may be mounted at a proper position on the main body 10 to form a laser pointer, which is applied to a meeting or a briefing.

According to the above description, it is apparent that the apparatus of the present invention comprises the following practical advantages of:

1. integrating the identification card, the entrance card, the MP3 player, and the mobile phone, which are hung on the neck of the user, with one another such that the neck of the user won't be full of various disorderly and confused articles.

2. enabling the user to keep the orderly and comely appearance, and especially providing the user with the multifunction device such that it is not necessary for the user to look all over for articles.

3. automatically changing status if there is an incoming phone call during music listening such that the user won't miss the timing of answering the phone call.

However, the above description merely illustrates the preferred embodiments of the present invention, and the applicable scope of the present invention is not limited hereto. Any obvious modification and revision made by a person skilled in the art are included within the spirit and scope of the present invention.

As described above, the present invention provides an improved display device of identification card that effectively integrates several structures commonly used by modern people with one another for easy use. The application that complies with utility is therefore submitted for a patent.

What the invention claimed is:

1. An improved display device of an identification card, the display device having a main body mounted thereon comprising:
several receiving clips mounted on a bottom edge and near a top edge of a front surface of the main body for receiving the identification card;
a speaker, a monitor, a microphone, a storage device, a connection part for coupling with a string that can be hung on the neck, a camera lens, several input/output devices, and several function buttons mounted on the periphery of the main body; and
a central processing unit (CPU) mounted on the inside of the main body, wherein the CPU is further connected to an analog to digital converter, a digital to analog converter, an audio amplifier, a digital signal processor, and a transmission interface so as to form a MP3 playing circuit, and the CPU is further connected to the camera lens and a Bluetooth chip module.

2. The improved display device of the identification card of claim 1, wherein the input/output devices comprises: a USB terminal, a wireless transmission device, and an earphone jack.

3. The improved display device of the identification card of claim 1, wherein the storage device is a memory card.

4. The improved display device of the identification card of claim 1, wherein an earphone applied to the main body is a hand-free mobile phone handset with a microphone.

5. The improved display device of the identification card of claim 1, wherein a LED light is mounted on the outside of the main body to form a laser pointer.
